(19) United States
(12) Patent Application Publication
(10) Pub. No.: US 2016/0160891 A1
(43) Pub. Date: Jun. 9, 2016

(54) Hydraulic Cylinder Structure

(71) Applicant: Vincent W. Lin, Chiayi City (TW)

(72) Inventor: Vincent W. Lin, Chiayi City (TW)

(21) Appl. No.: 14/564,385

(22) Filed: Dec. 9, 2014

(51) Int. Cl. F15B 15/14

(52) U.S. Cl. CPC F15B 15/1428; F15B 15/1457; F15B 15/149

(57) ABSTRACT

A hydraulic cylinder structure contains: a hydraulic cylinder including a movable piston rod, a connecting seat, and an oil tank having an outer tube and an inner tube. The piston rod is hollow and is fitted with a guiding tube of the connecting seat, and a pump of the connecting seat has an oil feeding pipe for outputting hydraulic oil. The oil feeding pipe is in connection with the guiding tube, an on/off valve, a pressure adjusting valve, and a safety valve. The pressure adjusting valve is coupled with an oil path of a push piston, and the oil path is joined with an auxiliary path and the on/off valve for drawing the hydraulic oil out of the oil tank via a single-direction valve, and the on/off valve and the safety valve are connected with the oil tank.

### BACKGROUND OF THE INVENTION

1. Field of the Invention

The present invention relates to a hydraulic cylinder structure which raises a piston rod quickly in an idle loading stroke and a low loading stroke to lift a heavy object.

2. Description of the Prior Art

A conventional hydraulic cylinder of a jack feeds hydraulic oil through a pump to push a piston, such that a piston rod extends outwardly to lift a heavy object (wherein a vertical jack contains a top disc fixed on a distal end of the piston rod, and a horizontal jack contains a top disc mounted on a swing arm, hence the vertical jack and the horizontal jack connect with a bottom end of a heavy object by ways of the top discs, and the piston rod extends outwardly or retracts inwardly to lift or descend the heavy object), so the piston rod slowly pushes the top disc upward (lifting speeds of the piston rod in a loading stroke or an idle loading stroke are the same).

To overcome above-mentioned shortcoming, a quick-lift hydraulic cylinder is developed and contains a guiding tube fitted with a hollow piston rod of the hydraulic cylinder, such that the hydraulic oil is feds into the piston rod via a pump and the guiding tube in an idle loading stroke (in the meantime, an oil path supplements the hydraulic oil into a single-directional oil tank to avoid a vacuum), and when a top disc contacts with the heavy object, a hydraulic oil pressure of the hydraulic cylinder is enhanced, so that a hydraulic oil pressure of the oil feeding pipe pushes a pressure adjusting valve into an oil path, and the pump outputs and feeds the hydraulic oil into the guiding tube and the oil path, such that the piston rod moves upward slowly to lift the heavy object, and an operating time in the idle loading stroke is saved to lift the heavy object quickly.

However, the pressure adjusting valve is defined between an oil feeding pipe and the oil path, so when the top disc contacts with the heavy object, the pressure adjusting valve is turned on to feed the hydraulic oil into the oil feeding pipe and the oil path, thus slowly moving the piston rod upward. It is inconvenient to lift a light object by using the jack, i.e., the light object is lifted by the jack slowly.

The present invention has arisen to mitigate and/or obviate the afore-described disadvantages.

SUMMARY OF THE INVENTION

The primary objective of the present invention is to provide a hydraulic cylinder structure which raises a piston rod quickly in an idle loading stroke and a low loading stroke to lift a heavy object.

To obtain above-mentioned objective, a hydraulic cylinder structure provided by the present invention contains: a hydraulic cylinder. The hydraulic cylinder includes a movable piston rod accommodated in a first end thereof and includes a connecting seat mounted on a second end thereof, the hydraulic cylinder also includes an oil tank comprised of an outer tube and an inner tube for sealing the piston rod, wherein the piston rod is hollow and is fitted with a guiding tube of the connecting seat, a pump of the connecting seat having an oil feeding pipe for outputting hydraulic oil which is drawn out of the oil tank via a check valve, wherein the oil feeding pipe is in connection with the guiding tube, an on/off valve, a pressure adjusting valve, and a safety valve; the pressure adjusting valve is coupled with an oil path of a push piston, and the oil path is joined with an auxiliary path and the on/off valve for drawing the hydraulic oil out of the oil tank via a single-direction valve, the on/off valve and the safety valve are connected with the oil tank, such that the pressure adjusting valve changes a pressure limitation of the hydraulic oil flowing through the oil path, and when a light object is lifted, the hydraulic oil directly feeds into the piston rod via the pump, the oil feeding pipe, and the guiding tube to lift the heavy object quickly.

Preferably, the pressure adjusting valve is adjusted based on using requirements, and a maximum pressure of the pressure adjusting valve is lower than a pressure of the safety valve, such that a jack operates safely and quickly, and a hydraulic oil pressure of the oil feeding pipe of the hydraulic cylinder relative to the heavy object pushes the pressure adjusting valve so that the hydraulic oil feeds into the oil path and the guiding tube to lift the heavy object slowly and safety.

### BRIEF DESCRIPTION OF THE DRAWINGS

FIG. 1 is a cross sectional view showing the assembly of a hydraulic cylinder structure according to a preferred embodiment of the present invention.

FIG. 2 is a cross sectional view showing the assembly of a connecting seat of the hydraulic cylinder structure according to the preferred embodiment of the present invention.

FIG. 3 is another cross sectional view showing the assembly of a connecting seat of the hydraulic cylinder structure according to the preferred embodiment of the present invention.

FIG. 4 is a cross sectional view showing the assembly of a pressure adjusting valve of the hydraulic cylinder structure according to the preferred embodiment of the present invention.

FIG. 5 is a plan view showing the operation of the hydraulic cylinder structure according to the preferred embodiment of the present invention.

FIG. 6 is a diagram of an oil feeding configuration of the hydraulic cylinder structure according to the preferred embodiment of the present invention.

### DETAILED DESCRIPTION OF THE PREFERRED

### Embodiments

The present invention will be clearer from the following description when viewed together with the accompanying drawings, which show, for purpose of illustrations only, a preferred embodiment in accordance with the present invention.

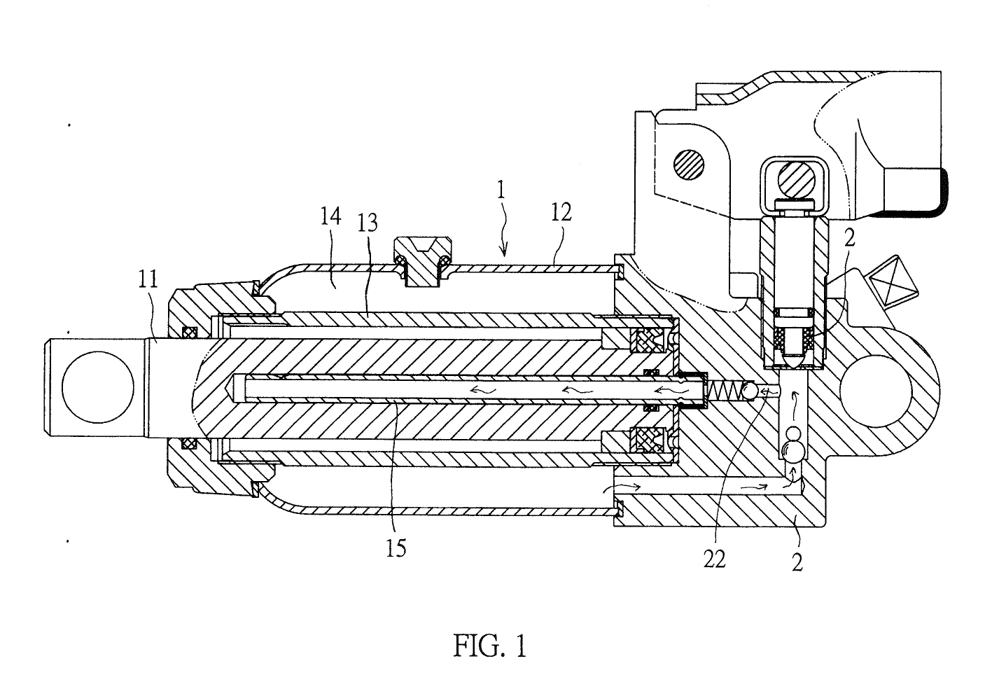

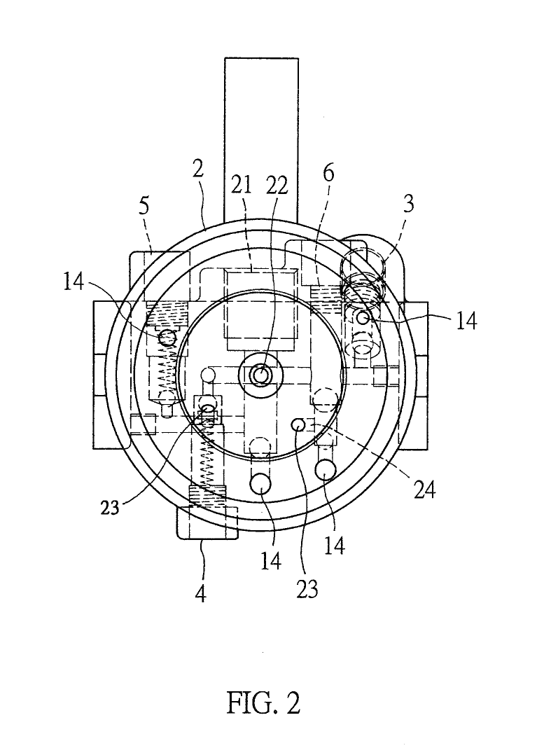

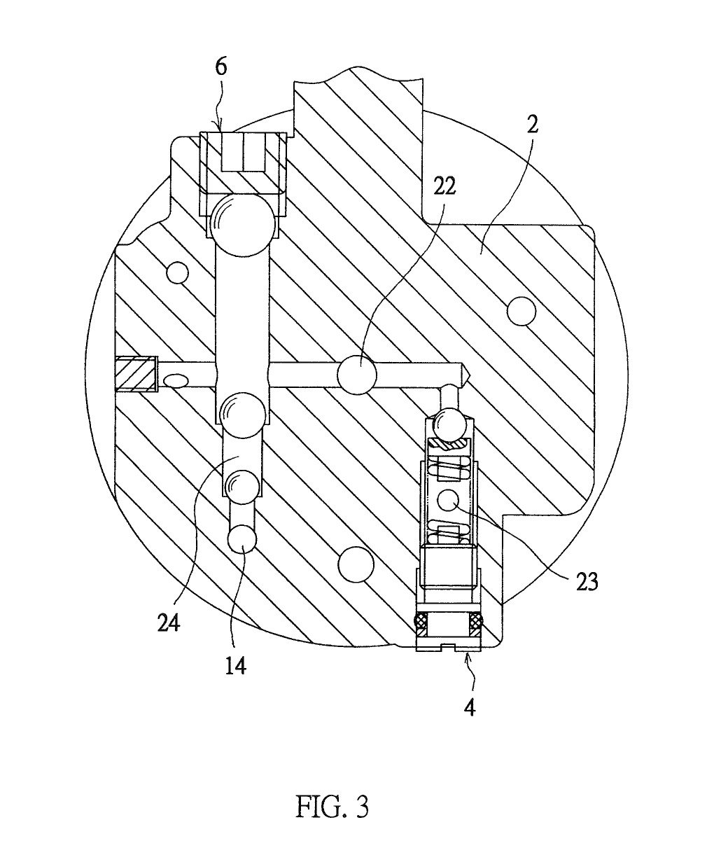

A hydraulic cylinder structure according to a preferred embodiment of the present invention comprises: a hydraulic cylinder 1 including a movable piston rod 11 accommodated in a first end thereof and a connecting seat 2 mounted on a second end thereof (as shown in FIG. 1). The hydraulic cylinder 1 also includes an oil tank 14 comprised of an outer tube 12 and an inner tube 13 for sealing the piston rod 11, wherein the piston rod 11 is hollow and is fitted with a guiding tube 15 of the connecting seat 2. A pump 21 of the connecting seat 2 has an oil feeding pipe 22 for outputting hydraulic oil which is drawn out of the oil tank 14 via a check valve (as illustrated in FIG. 2), wherein the oil feeding pipe 22 is in connection with the guiding tube 15, an on/off valve 3, a pressure adjusting valve 4, and a safety valve 5, the pressure adjusting valve 4 is coupled with an oil path 23 of a push piston, and the oil path 23 is joined with an auxiliary path 24 (as shown in FIG. 3) and the on/off valve 3 for drawing the hydraulic oil out of the oil tank 14 via a single-direction valve 6, the on/off valve 3 and the safety valve 5 are connected with the oil tank 14.

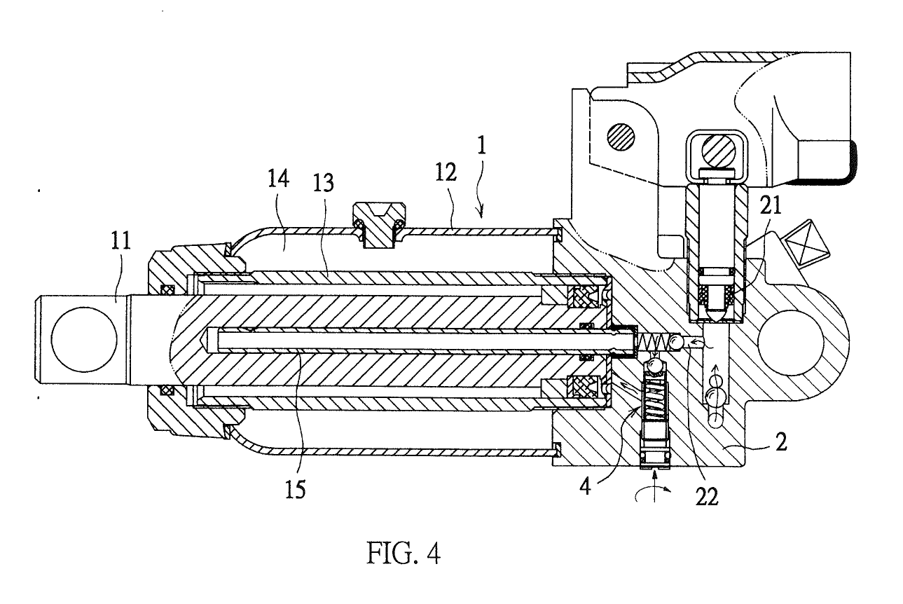

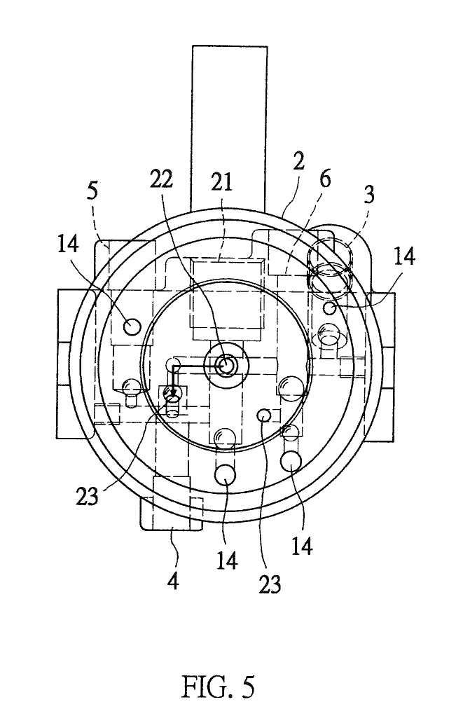

Thereby, when the pump 21 draws and outputs the hydraulic oil out of the oil tank 14, the hydraulic oil of the oil feeding pipe 22 is fed into the guiding tube 15 to push the piston rod 11 outwardly, during which the oil path 23 draws the hydraulic oil out of the oil tank 14 through the single-direction valve 6 by using a vacuum suction, such that the hydraulic oil is directly fed into the oil path 23 via the auxiliary path 24, and the hydraulic oil is outputted out of the pump 21 and is completely fed into the guiding tube 15 to push the piston rod 11, thus operating in an idle loading stroke to lift the piston rod 11. When the piston rod 11 supports a heavy object, a hydraulic oil pressure of the oil feeding pipe 22 of a hydraulic cylinder 1 relative to the heavy object is limited by a pressure of the pressure adjusting valve 4, and the pressure adjusting valve 4 is turned on to feed into the oil path 23 (as shown in FIGS. 4 and 5). When a pressure of the heavy object is less than a pressure limitation of the pressure adjusting valve 4, the hydraulic oil of the oil feeding pipe 22 completely feeds into the guiding tube 15 quickly to lift the heavy object, and when the pressure of the heavy object is greater than the pressure limitation of the pressure adjusting valve 4, the pressure adjusting valve 4 is turned on to connect with the oil path 23, such that the pump 21 outputs and feeds the hydraulic oil into the guiding tube 15 and the oil path 23 to lift the piston rod 11 slowly, thus lifting the heavy object. When the pressure of the heavy object is more than a limitation of the safety valve 5, the pump 21 pushes the hydraulic oil outputted by the oil feeding pipe 22 to flow back to the oil tank 14 through the safety valve 5, thereby protecting the hydraulic 1. Thereafter, the on/off valve 3 is turned on so that the hydraulic oil in the guiding tube 15 and the oil path 23 flows back to the oil tank 12, thus retracting the piston rod 11.

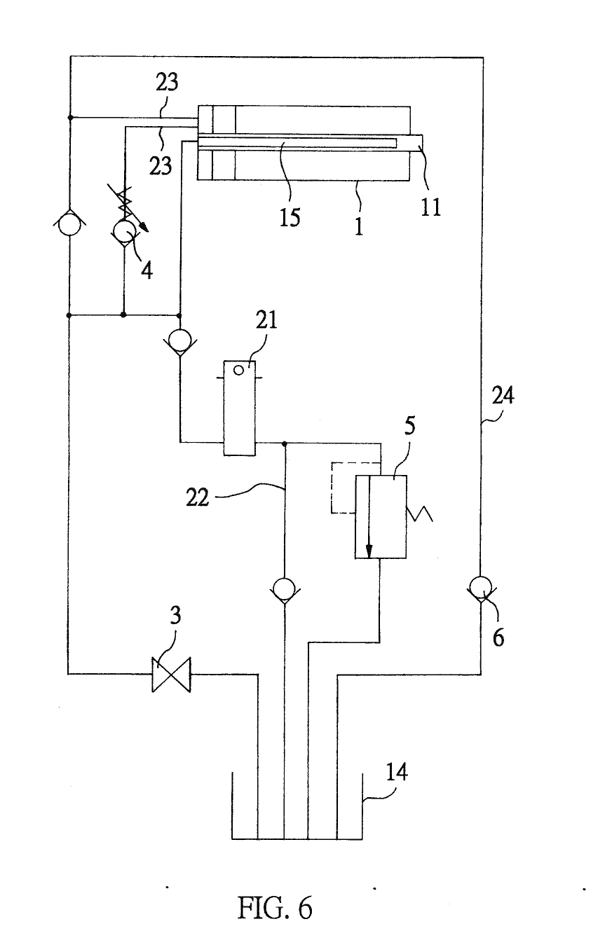

According to above-described structure, between the oil feeding pipe 22 and the oil path 23 is defined the pressure adjusting valve 4 (as illustrated in FIG. 6), such that the pressure limitation of the hydraulic oil flowing through the oil path 23 is change, and the pressure of the pressure adjusting valve 4 relative to a weight of the heavy object is adjusted. Thereby, when a jack lifts a light object, the pressure of the pressure adjusting valve 4 is raised so that when a top disc of the jack contacts a bottom end of the light object, the light object relative to the hydraulic oil pressure of the oil feeding pipe 22 of the hydraulic cylinder 1 is less than the pressure limitation of the pressure adjusting valve 4, so the hydraulic oil is directly fed into the piston rod 11 via the pump 21, the oil feeding pipe 22, and the guiding tube 15, such that the jack lifts the light object quickly and easily.

While various embodiments in accordance with the present invention have been shown and described, it is clear to those skilled in the art that further embodiments may be made without departing from the scope of the present invention.

What is claimed is:

1. A hydraulic cylinder structure comprising:
a hydraulic cylinder including a movable piston rod accommodated in a first end thereof and a connecting seat mounted on a second end thereof, the hydraulic cylinder also including an oil tank comprised of an outer tube and an inner tube for sealing the piston rod, wherein the piston rod is hollow and is fitted with a guiding tube of the connecting seat, a pump of the connecting seat having an oil feeding pipe for outputting hydraulic oil which is drawn out of the oil tank via a check valve, wherein the oil feeding pipe is in connection with the guiding tube, an on/off valve, a pressure adjusting valve, and a safety valve; the pressure adjusting valve is coupled with an oil path of a push piston, and the oil path is joined with an auxiliary path and the on/off valve for drawing the hydraulic oil out of the oil tank via a single-direction valve, the on/off valve and the safety valve are connected with the oil tank, such that the pressure adjusting valve changes a pressure limitation of the hydraulic oil flowing through the oil path, and when a light object is lifted, the hydraulic oil directly feeds into the piston rod via the pump, the oil feeding pipe, and the guiding tube to lift the heavy object quickly.
